(19) United States
(12) Patent Application Publication
(10) Pub. No.: US 2017/0364916 A1
(43) Pub. Date: Dec. 21, 2017

(54) SYSTEMS AND METHODS FOR BUILDING PEER NETWORKS

(71) Applicant: MasterCard International Incorporated, Purchase, NY (US)

(72) Inventors: Srinivasarao Nidamanuri, Chesterfield, MO (US); Vincent A. Haulotte, Manchester, MO (US); Nicholas J. Boschert, Dardenne Prairie, MO (US)

(21) Appl. No.: 15/185,922

(22) Filed: Jun. 17, 2016

(51) Int. Cl. G06Q 20/40; G06Q 20/22; H04L 12/24; H04L 29/08

(52) U.S. Cl. CPC G06Q 20/4016; H04L 67/22; H04L 67/12; G06Q 20/223; H04L 41/12; G06Q 20/405; H04L 67/1042

(57) ABSTRACT

A network builder (NB) computing device for building a peer network used to authenticate suspect payment transactions and thereby improve data security over a payment network is provided. The NB computing device includes a processor in communication with a memory. The processor retrieves candidate historical transaction data for a candidate cardholder including a first plurality of historical data elements and retrieves model historical transaction data for a plurality of model cardholders including a second plurality of historical data elements. The model historical transaction data includes previously authenticated and authorized payment transactions. The processor compares the candidate historical transaction data to the model historical transaction data, identifies matching historical data elements, and builds a first peer network between the candidate cardholder and a first set of model cardholders associated with the matching historical data elements. The first peer network is stored in the memory.

### BACKGROUND

The field of the disclosure relates generally to building peer networks for data security, and more specifically to network-based systems and methods for building peer networks between a candidate user and a plurality of model users by matching historical transaction data between the users, and using the peer networks for data security including detecting fraudulent payment transactions.

Data security is extremely important in the online digital age. Computer messages are constantly being sent back and forth between computer devices. It is important that these messages be secure and authenticated. In other words, it is important that a user of one computer device can be ensured that the message they received came from the legitimate sender of the message. For example, in the payment transaction industry, it is important that purchases made by a cardholder are authorized while unauthorized or fraudulent purchases are identified and declined.

At least some known payment processing systems analyze transaction data of a candidate transaction associated with a cardholder during an authorization process to determine if the candidate transaction is legitimate or potentially fraudulent. These known payment processing systems typically analyze transaction elements from the candidate transaction (e.g., date, merchant, transaction amount, and location) and compare the transaction elements to transaction elements from historical transaction data of the cardholder. Based on the comparison, the payment processing systems determines whether or not the candidate transaction is potentially an unauthorized transaction (i.e., fraudulent). For example, some known payment processing systems may determine that a candidate transaction of a cardholder is likely fraudulent because the candidate transaction data does not match historical transaction data of the cardholder. An authorization system may reject the candidate transaction in response to such a determination.

Unfortunately, some of these known fraud protection systems may determine that a candidate transaction legitimately initiated by the cardholder is potentially fraudulent and reject the candidate transaction. In one example, a cardholder may purchase new appliances for the first time at a store the cardholder has not visited in the past. Using the known fraud protection systems, these systems may determine that the purchase has a high risk of being fraudulent and decline the purchase despite the cardholder initiating the purchase because the cardholder does not have historical transaction data matching the purchase. Declining legitimate transactions of a cardholder may be frustrating and inconvenient for the cardholder, which may lead to a reduced number of purchases made by the cardholder.

### BRIEF DESCRIPTION

In one aspect, a network builder (NB) computing device for building a peer network used to authenticate suspect payment transactions and thereby improve data security over a payment network is provided. The NB computing device includes a processor in communication with a memory. The processor retrieves candidate historical transaction data for a candidate cardholder including a first plurality of historical data elements and retrieves model historical transaction data for a plurality of model cardholders including a second plurality of historical data elements. The model historical transaction data includes previously authenticated and authorized payment transactions. The processor compares the candidate historical transaction data to the model historical transaction data, identifies matching historical data elements, and builds a first peer network between the candidate cardholder and a first set of model cardholders associated with the matching historical data elements. The first peer network is stored in the memory.

In another aspect, a method for building a peer network used to authenticate suspect payment transactions and thereby improve data security over a payment network is provided. The method is at least partially implemented by a network building (NB) computing device. The method includes retrieving candidate historical transaction data for a candidate cardholder including a first plurality of historical data elements and retrieving model historical transaction data for a plurality of model cardholders including a second plurality of historical data elements. The model historical transaction data includes previously authenticated and authorized payment transactions. The method further includes comparing the candidate historical transaction data to the model historical transaction data, identifying matching historical data elements between the first plurality of historical data elements and the second plurality of historical data elements, building a first peer network between the candidate cardholder and a first set of model cardholders associated with the matching historical data elements, and storing the first peer network in a memory associated with the NB computing device.

In a further aspect, computer-readable storage media for building a peer network used to authenticate suspect payment transactions and thereby improve data security over a payment network is provided. The computer-readable storage media has computer-executable instructions embodied thereon. When executed by at least one processor, the computer-executable instructions cause the processor to retrieve candidate historical transaction data for a candidate cardholder including a first plurality of historical data elements and retrieve model historical transaction data for a plurality of model cardholders including a second plurality of historical data elements. The model historical transaction data includes previously authenticated and authorized payment transactions. The computer-executable instructions further cause the processor to compare the candidate historical transaction data to the model historical transaction data, identify matching historical data elements between the first plurality of historical data elements and the second plurality of historical data elements, build a first peer network between the candidate cardholder and a first set of model cardholders associated with the matching historical data elements, and store the first peer network in a memory associated with the processor.

### BRIEF DESCRIPTION OF THE DRAWINGS

The figures listed below show example embodiments of the methods and systems described herein.

FIGS. 1-5 show example embodiments of the methods and systems described herein.

FIG. 1 is a schematic diagram illustrating an example multi-party payment card system for enabling ordinary payment-by-card transactions in which merchants and card issuers do not necessarily have a one-to-one relationship.

FIG. 2 illustrates an is an expanded block diagram of an example embodiment of a server system that may be used to build peer networks that may be used in the system shown in FIG. 1.

FIG. 3 is a simplified data flow diagram of building peer networks of cardholders with the system shown in FIG. 1.

FIG. 4 is a simplified diagram of an example method of building peer networks using the system shown in FIG. 1.

FIG. 5 is a diagram of components of one or more example computing devices that may be used in the environment shown in FIG. 4.

Although specific features of various embodiments may be shown in some drawings and not in others, this is for convenience only. Any feature of any drawing may be referenced and/or claimed in combination with any feature of any other drawing.

### DETAILED DESCRIPTION

The following detailed description of the embodiments of the disclosure refers to the accompanying drawings. The same reference numbers in different drawings may identify the same or similar elements. Also, the following detailed description does not limit the claims.

The system described herein is configured to build peer networks of cardholders to authenticate suspect payment transactions (i.e., transactions indicated as potentially fraudulent) and thereby improve data security. As used herein, a “peer network” refers to a plurality of cardholders that are linked together based on one or more similar purchases. The peer networks enable the system to analyze suspect payment transactions that do not match a historical purchasing profile of the purchaser, and determine that these transactions are not fraudulent because although the candidate transactions do not match the historical profile, they match historical purchases made by other purchasers linked to the candidate purchaser within a peer network that have been previously authenticated and authorized. The system includes a network builder (NB) computing device in communication with a payment processor configured to process payment transactions and/or interact with a database that stores data related to the transactions (“transaction data”). The NB computing device includes a processor in communication with a memory. The NB computing device is in communication with at least one database for storing information, such as historical transaction data, cardholder profiles, and peer networks. A cardholder profile is associated with each cardholder and includes data associated with the cardholder, such as transaction data and peer networks.

The NB computing device is configured to receive historical transaction data for a candidate cardholder (also referred to as “candidate historical transaction data”). The transaction includes a plurality of data or transaction elements such as a transaction amount, a description of the purchase made, a merchant identifier, an account identifier (associating the transaction with a consumer or account holder), a point-of-sale (POS) entry mode, a transaction type (e.g, card present or card-not-present), and a time and date stamp. In some implementations, each transaction may further include additional data elements such as a location identifier, which may identify where the transaction was initiated (i.e., a location of the consumer) and/or the location of the merchant. In at least some embodiments, the data elements may include one or more cardholder characteristics, such as age or marital status. The NB computing device is also configured to retrieve historical transaction data for one or more model cardholders (i.e., other cardholders being used to compare to the candidate cardholder) that has matching or similar data elements for each transaction of the historical transaction data. The historical transaction data for the model cardholders may also be referred to as “model historical transaction data”. In some embodiments, the historical transaction data for the model cardholders may not include transactions indicated as fraudulent.

The NB computing device is configured to compare the candidate historical transaction data for the candidate cardholder to the model historical transaction data for the model cardholders. The NB computing device identifies model cardholders that have made purchases similar to purchases made by the candidate cardholder. In particular, the NB computing device identifies similar or matching historical data elements of the candidate historical transaction data and the model historical transaction data.

The NB computing device is configured to build one or more peer networks of purchasing peers between the candidate cardholder and the model cardholders based on the comparison. Each peer network links the candidate cardholder to a set of model cardholders having similar purchases or purchasing behaviors as the candidate cardholder. The more matching data elements there are between cardholders in the peer network, the stronger the connection between the candidate cardholder and the set of model cardholders. In some embodiments, a network strength value may be calculated from the matching data elements. Weighting factors may be applied by the NB computing device to one or more data elements to prioritize certain data elements over others. For example, the NB computing device may apply a weighting factor to a data element associated with a merchant location such that cardholders that make purchases at the same merchant location are more likely to be grouped together.

In the example embodiment, the payment processor receives first transaction data associated with a purchase made by the candidate cardholder. The payment processor performs a fraud modeling process and determines that the first transaction data is suspected as potentially fraudulent (referred to herein as the “suspected purchase”). In the example embodiment, the payment processor retrieves historical transaction data associated with the candidate cardholder to identify any historical transaction data of the candidate cardholder that may indicate whether or not the suspect purchase is legitimate or non-fraudulent. If the payment processor determines that the first transaction data does not match the historical transaction data, the payment processor sends the first transaction data to the NB computing device.

The NB computing device is configured to retrieve the first transaction data and retrieve the peer networks associated with the candidate cardholder. In the example embodiment, the NB computing device retrieves historical transaction data for the model cardholders of the peer networks. The NB computing device compares suspect data elements of the first transaction data to peer data elements associated with each model cardholder in each peer network associated with the candidate cardholder. The NB computing device counts the number of matching data elements. In some embodiments, when weighting factors are applied to particular data elements, the NB computing device may calculate a score based on the matching data elements. The NB computing device is configured to determine how many model cardholders have performed similar purchases to the suspect purchase made by the candidate cardholder and how similar these purchases are. The more matching data elements there are, the stronger the similarities between the purchases. The matching data elements indicate that the suspect purchase made by the candidate cardholder may be similar to purchases made by the model cardholders with similar purchasing behaviors. Since the purchases made by the model cardholders have been previously authenticated and authorized, matching the purchase made by the cardholder with one or more purchases made by the model cardholders may indicate that the suspect purchase was legitimately made by the cardholder.

Based on the determination, the NB computing device is configured to generate one or more confidence scores for the first transaction data and transmit the confidence scores to the payment processor. The confidence scores indicate whether or not the first transaction data is potentially non-fraudulent. Using the historical transaction data for the model cardholders of the peer networks associated with the candidate cardholder enables the NB computing device to generate confidence scores for purchases made that do not match the historical transaction data of the candidate cardholder. If the confidence scores indicate the first transaction data is potentially non-fraudulent, the payment processor may approve the first transaction data.

In one example, a candidate cardholder completes several purchases at an electronics store in a short period of time, including a $399.99 purchase. The $399.99 purchase does not match with historical transaction data associated with the candidate cardholder. The payment processor may identify the purchases as potentially fraudulent. However, the NB computing device may identify one or more peers in peer networks associated with the candidate cardholder that have made similar purchases that are non-fraudulent. The NB computing device generates a confidence score based on the similar purchases and transmits the confidence score to the payment processor for approval of the $399.99 purchase.

In another example, a merchant has opened a new merchant location near a candidate cardholder. The candidate cardholder makes a purchase at the merchant for the first time. The payment processor identifies the purchase as potentially fraudulent. However, the candidate cardholder is linked to a peer network associated with cardholders located near the candidate cardholder. Other cardholders in the peer network may make similar or identical purchases as the purchase made by the candidate cardholder. The BN computing device determines the transaction data of the other cardholders matches the purchase made by the candidate cardholder and generates a confidence score indicating the purchase is potentially non-fraudulent.

The systems and methods described herein are configured to facilitate (a) improved data security over a payment network; (b) increased number of non-fraudulent payments processed over a payment network; (c) historical transaction data extending between multiple cardholders for use in authorization process; and (d) improved mapping and correlation between cardholders and the cardholders' related historical transaction data.

The technical effects of the systems and methods described herein can be achieved by performing at least one of the following steps: (i) retrieving candidate historical transaction data for a candidate cardholder including a first plurality of historical data elements; (ii) retrieving model historical transaction data for a plurality of model cardholders including a second plurality of historical data elements; (iii) comparing the candidate historical transaction data to the model historical transaction data; (iv) identifying matching historical data elements between the first plurality of historical data elements and the second plurality of historical data elements; (v) building a first peer network between the candidate cardholder and a first set of model cardholders associated with the matching historical data elements; (vi) storing the first peer network in a memory; (vii) receiving first transaction data associated with a suspect payment transaction made by the candidate cardholder from a payment processor, the first transaction data including a plurality of suspect data elements; (viii) retrieving the first peer network associated with the candidate cardholder and including a plurality of peer data elements; (ix) comparing the first transaction data and the first peer network; and (x) identifying matching peer data elements between the suspect data elements and the peer data elements for each model cardholder associated with the first peer network.

The following detailed description of the embodiments of the disclosure refers to the accompanying drawings. The same reference numbers in different drawings may identify the same or similar elements. Also, the following detailed description does not limit the claims.

In situations in which the systems discussed herein collect personal information about users, or may make use of personal information, the users may be provided with an opportunity to control whether programs or features collect user information. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as a city, a ZIP code, or state level), so that a particular location of a user cannot be determined. Thus, the user may have control over how information is collected about the user and used by the systems.

Described herein are computer systems such as NB computing devices and user computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the determination and analysis of characteristics of devices used in payment transactions.

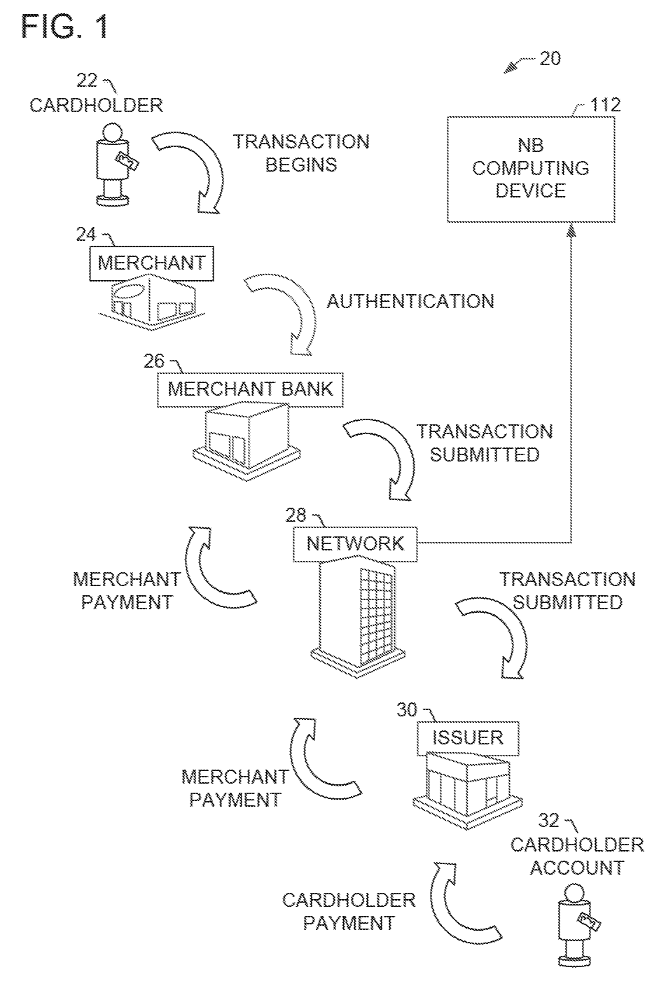

FIG. 1 is a schematic diagram illustrating an example multi-party transaction card industry system 20 for enabling ordinary payment-by-card transactions, including payment-by-card transactions made by cardholders using cardholder computing devices to initiate transactions at an online merchant, in which merchants 24 and card issuers 30 do not need to have a one-to-one special relationship. Typical financial transaction institutions provide a suite of interactive, online applications to both current and prospective customers. For example, a financial transactions institution may have a set of applications that provide informational and sales information on their products and services to prospective customers, as well as another set of applications that provide account access for existing cardholders.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

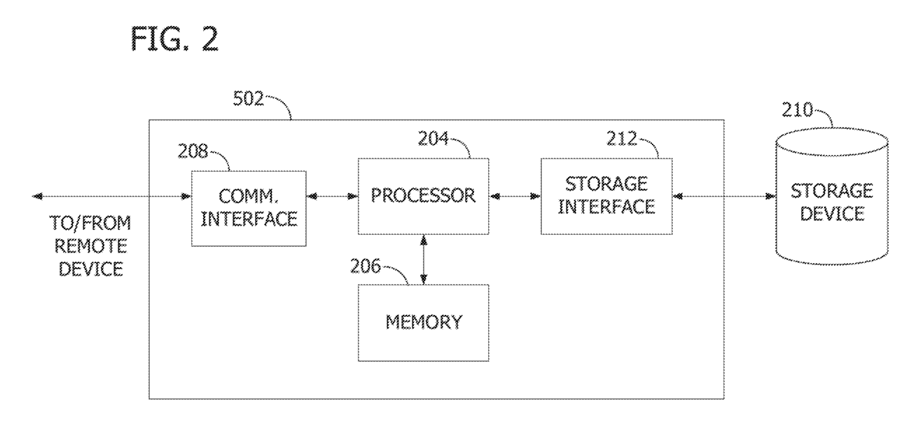

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including network builder (NB) computing device 112. In the example embodiment, interchange network 28 provides such transaction data and additional transaction data such as historical transaction data. In alternative embodiments, any party may provide such transaction data and historical transaction data to SSI computing device 112.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, NB computing device 112 may be used to building peer networks with a plurality of cardholders to increase a number of non-fraudulent purchases processed by system 20 using transaction data and historical transaction data received from, for example, interchange network 28. Although the systems described herein are not intended to be limited to facilitate such applications, the systems are described as such for exemplary purposes.

FIG. 2 illustrates an example configuration of a host computing system 202 such as NB computing device 112 (shown in FIG. 1). In the example embodiment, server system 202 retrieves and analyzes historical transaction data to build peer networks of cardholders, as described below.

Server system 202 includes a processor 204 for executing instructions. Instructions may be stored in a memory area 206, for example. Processor 204 may include one or more processing units (e.g., in a multi-core configuration) for executing instructions. The instructions may be executed within a variety of different operating systems on the server system 202, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 204 is operatively coupled to a communication interface 208 such that server system 202 is capable of communicating with a remote device such as a user system or another server system 202. For example, communication interface 215 may receive requests from interchange network 28 via the Internet, as illustrated in FIG. 1.

Processor 204 may also be operatively coupled to a storage device 210. Storage device 210 is any computer-operated hardware suitable for storing and/or retrieving data. In some embodiments, storage device 210 is integrated in server system 202. For example, server system 202 may include one or more hard disk drives as storage device 210. In other embodiments, storage device 210 is external to server system 202 and may be accessed by a plurality of server systems 202. For example, storage device 210 may include multiple storage units such as hard disks or solid state disks in a redundant array of inexpensive disks (RAID) configuration. Storage device 210 may include a storage area network (SAN) and/or a network attached storage (NAS) system.

In some embodiments, processor 205 is operatively coupled to storage device 210 via a storage interface 212. Storage interface 212 is any component capable of providing processor 204 with access to storage device 210. Storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 204 with access to storage device 210.

Memory area 206 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

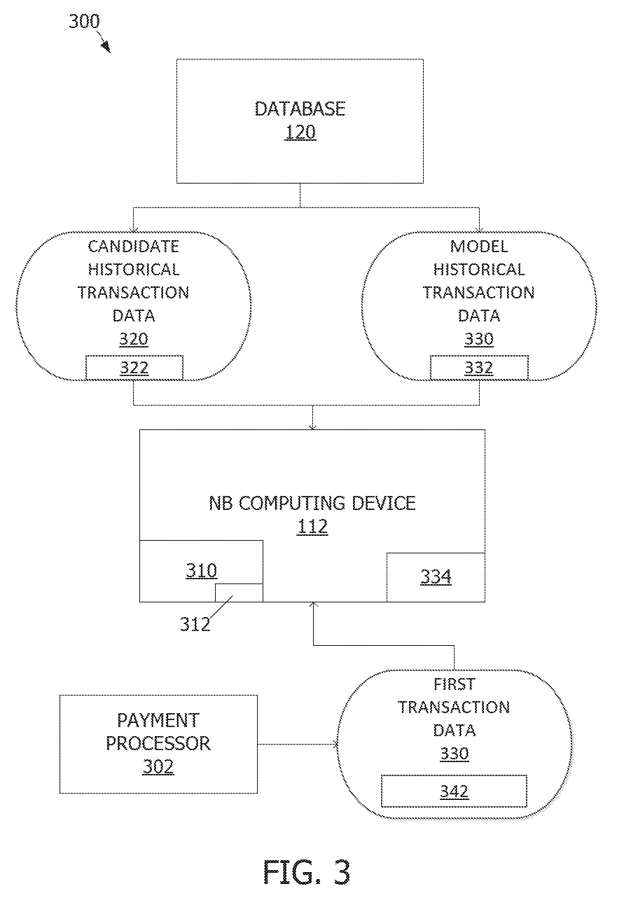

FIG. 3 is a simplified data flow diagram 300 for building peer networks using NB computing device 112 of FIG. 1. NB computing device 112 builds peer networks 310 associated with a plurality of cardholders. Candidate historical transaction data 320 represents previously processed transaction data from previous consumer transactions associated with a candidate cardholder (e.g., cardholder 22, shown in FIG. 1). In at least one example, candidate historical transaction data 320 may be stored at a transaction data database 120. In alternative examples, candidate historical transaction data 320 may be stored at other systems or received from a payment network computer system associated with payment network 28.

NB computing device 112 receives candidate historical transaction data 320 associated with a plurality of historical transactions. Such candidate historical transaction data 320 may be associated with a plurality of merchants. Candidate historical transaction data 320 includes a plurality of historical data elements 322 that include information for each purchase associated with candidate historical transaction data 320. For example, historical data elements 322 that may include, but is not limited to, transaction amounts, transaction volumes, transaction categories, product identifiers, transaction location, cardholder residence location, merchant location, transaction date and time, merchant identifiers, transactions types (card present or card-not-present), point-of-sale (POS) modes, and cardholder numbers.

However, in some examples, received candidate historical transaction data 320 may not include all such historical data elements 322 and NB computing device 112 may infer historical data elements 322 or retrieve historical data elements 322 from another source. For example, candidate historical transaction data 320 may not include a cardholder residence location. NB computing device 112 may process candidate historical transaction data 320 to predict a likely cardholder residence location based on merchant locations for candidate historical transaction data 320 associated with the candidate cardholder. Similarly, not all candidate historical transaction data 320 includes transaction categories. However, transaction categories may be determined based on merchant identifiers. For example, a merchant identifier “ABC” associated with a hardware store may be identified by NB computing device 112. NB computing device 112 may determine that candidate historical transaction data 320 with a merchant identifier of “ABC” may have a transaction category of “Hardware”.

NB computing device 112 is configured to retrieve model historical data 330 associated with one or more model cardholders. Similar to candidate historical transaction data 320, model historical transaction data 330 includes a plurality of historical data elements 332 and may be stored in a database such as database 120. The model cardholders may be selected based on having model historical transaction data 330 with one or more data elements 332 that substantially match data elements 322. In other embodiments, the model cardholders may be selected randomly or using different selection scheme.

NB computing device 112 is configured to compare historical data elements 322 and historical data elements 332 to identify matching historical data elements. By matching data elements, NB computing device 112 identifies model cardholders that make similar purchases or have other similarities to the candidate cardholder. Accordingly, model historical transaction data 330 from model cardholders similar to the candidate cardholder may be used during authentication and authorization of a suspect purchase to avoid the transaction being declined as potentially fraudulent. Although referred to as “matching data elements”, it should be understood that historical data elements 322, 332 may be identified as matching if historical data elements 322, 332 are within a predetermined threshold value of each other. For example, a first transaction occurring at 11:00 AM on December 1 may be matched to a second transaction occurring at 3:45 PM on December 1. NB computing device 112 may calculate or count a matching value associated with each model cardholder for the number of matching historical data elements between historical data elements 322 of the candidate cardholder and historical data elements 332 of each model cardholder. In the example embodiment, NB computing device 112 applies one or more weighting factors 334 to the matching historical data elements to prioritize certain data elements over others. For example, weighting factors 334 may be applied to a merchant identifier and location identifier to prioritize model cardholder that have made purchases at the same merchant location as the candidate cardholder.

Once the matching historical data elements have been identified, NB computing device 112 determines whether or not to build peer network 310. In the example embodiment, NB computing device 112 determines whether or not to build peer network 310 based on a number of model cardholder associated with the matching data elements and the number of matching historical data elements or matching value calculated by NB computing device 112. If the number of model cardholders is exceeds a predetermined threshold value, peer network 310 may include too much historical data 330 for reliably determining that a suspect purchase is not fraudulent as described herein. Additionally or alternatively, if the count or matching value is below a predetermined threshold value, the candidate cardholder and the model cardholders may not have sufficient similarities to use model historical transaction data 330 to determine a suspect purchase of the candidate cardholder is not fraudulent as described herein. In other embodiments, NB computing device 112 whether or not to build peer network 310 based on other factors, such as a number of peer networks 310 that the candidate cardholder is linked to.

If NB computing device 112 determines to build peer network 310, candidate historical transaction data 320 and a portion of model historical transaction data 330 is are added to peer network 310 to link the candidate cardholder and at least some model cardholders together. The portion of model historical transaction data 330 is associated with a set of the model cardholders that have the same matching historical data elements with the candidate cardholder. For example, one peer network 310 may be built for cardholders that make purchases at a particular merchant location or cardholders that make purchases exceeding a predefined transaction amount with a merchant every month. These peer networks 310 facilitate authenticating a cardholder for suspect purchases using other cardholders' transaction data to determine whether or not the suspect purchases has been misidentified as potentially fraudulent. In some embodiments, NB computing device 112 may determine a network size (i.e., a number of cardholders) and a network strength (i.e., a number of matching data elements shared by the cardholders) for each peer network 310. Peer network 310 includes a plurality of peer data elements 312 associated with the cardholders and transaction data linked to peer network 310.

In the example embodiment, a payment processor 302 associated with interchange network 28 (shown in FIG. 1) receives first transaction data 340 associated with a suspect purchase made by the candidate cardholder of peer network 310. Payment processor 302 performs a fraud modeling process and determines that the suspect purchase is potentially fraudulent. In the example embodiment, payment processor 302 retrieves candidate historical transaction data 320 associated with the candidate cardholder, compares first transaction data 340 and candidate historical transaction data 320, and determines that the first transaction data 340 does not match candidate historical transaction data 320. Payment processor 302 sends first transaction data 340 to NB computing device 112.

NB computing device 112 is configured to retrieve first transaction data 340 and retrieve peer networks 310 associated with the candidate cardholder. In the example embodiment, NB computing device 112 retrieves historical transaction data for the model cardholders of peer networks 310. NB computing device 112 compares peer data elements 312 of peer networks 310 to a plurality of suspect data elements 342 associated with first transaction data 340. NB computing device 112 is configured to count a number of matching peer data elements between peer networks 310 and first transaction data 340. In some embodiments, weighting factors 334 are applied to the matching peer data elements to calculate a matching value between first transaction data 340 and peer network 310. NB computing device 112 is configured to determine how many model cardholders have performed similar purchases to the suspect purchase made by the candidate cardholder and how similar these purchases are. The more matching peer data elements there are, the stronger the similarities between the purchases. The matching peer data elements indicate that the suspect purchase made by the candidate cardholder may be similar to purchases made by the model cardholders with similar purchasing behaviors. Since the purchases made by the model cardholders have been previously authenticated and authorized, matching the suspect purchase made by the candidate cardholder with one or more purchases made by the model cardholders may indicate that the suspect purchase made by the cardholder is legitimate or non-fraudulent (i.e., the purchase is authenticated). If the purchases made by the model cardholders do not match the suspect purchase, the suspect purchase may still be potentially fraudulent.

Based on the determination, NB computing device 112 notifies payment processor 302 whether or not the suspect purchase is authenticated. In at least some embodiments, NB computing device 112 is configured to generate one or more confidence scores associated with first transaction data 340 and transmit the confidence scores to payment processor 302. The confidence scores indicate whether or not first transaction data 340 is potentially non-fraudulent. The confidence scores may be based on, for example, the matching peer data elements between first transaction data 340 and peer network 310, and the network size and strength of peer network 310. Using historical transaction of the model cardholders associated with peer network 310 enables NB computing device 112 to generate confidence scores for purchases made by the candidate cardholder that do not match candidate historical transaction data 320. If the confidence scores indicate first transaction data 340 is potentially non-fraudulent, the candidate cardholder may be authenticated and payment processor 302 may approve or authorize first transaction data 340 to be processed.

NB computing device 112 enables an increased number of non-fraudulent purchases to be processed. In particular, payment transactions that deviate from a cardholder's historical transaction data may be authenticated using peer historical peer transaction data. Accordingly, fraud detection systems and methods may be used in combination with NB computing device 112 to detect potentially fraudulent charges while legitimate transaction are still processed, thereby improving the data security of the payment network.

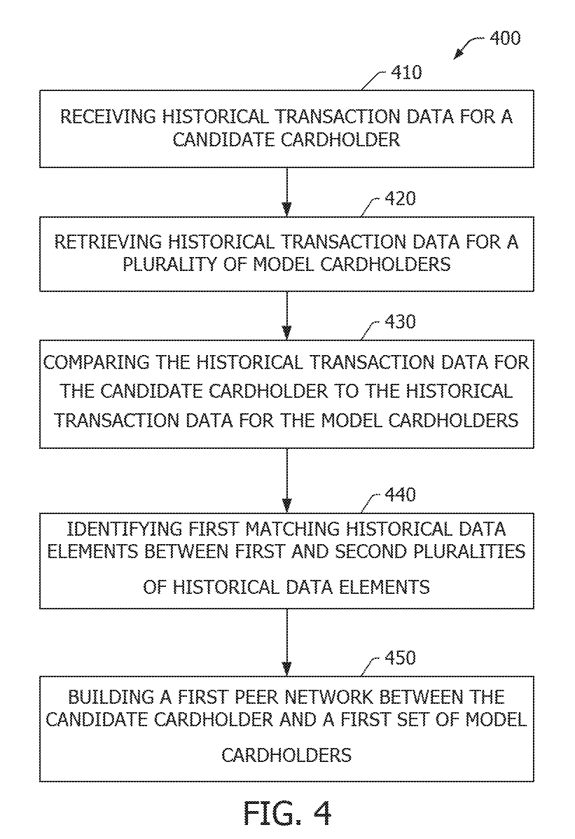

FIG. 4 is a simplified diagram of an example method 400 of building peer networks of cardholders using NB computing device 112 (shown in FIG. 3). Method 400 is accordingly carried out by NB computing device 112. NB computing device 112 receives 410 candidate historical transaction data 320 associated with a candidate cardholder from payment processor 302 (each shown in FIG. 3). NB computing device 112 is configured to retrieve 420 model historical transaction data 330 (shown in FIG. 3) associated with a plurality of model cardholders.

NB computing device 112 additionally is configured to compare 430 candidate historical transaction data 320 and model historical transaction data 330. More specifically, NB computing device 112 is configured to compare 430 one or more historical data elements 322, 332 (shown in FIG. 3) of candidate historical transaction data 320 and model historical transaction data 330. NB computing device 112 is further configured to identify 440 a set of matching historical data elements between candidate historical transaction data 320 and model historical transaction data 330. The matching historical data elements are historical data elements shared between candidate historical transaction data 320 and model historical transaction data 330 for at least some model cardholders. NB computing device 112 is configured to build 450 a peer network (e.g., peer network 310, shown in FIG. 3) between the candidate cardholder a set or portion of the model cardholders associated with the matching historical data elements.

In at least some embodiments, NB computing device 112 also is configured to receive first transaction data 340 (shown in FIG. 3) associated with a suspect purchase made by the candidate cardholder from payment processor 302. NB computing device 112 retrieves the previously-built peer network and compares suspect data elements 342 of transaction data 340 (both shown in FIG. 3) and peer data elements of the peer network to identify any matching peer data elements. NB computing device 112 may authenticate the suspect transaction based on the matching peer data elements and notify payment processor 302. In certain embodiments, NB computing device 112 is configured to generate one or more confidence scores based on the matching peer data elements between first transaction data 340 and the peer network. NB computing device 112 may transmit the confidence scores to payment processor 302 to determine whether or not to authenticate the cardholder and authorize the suspect transaction.

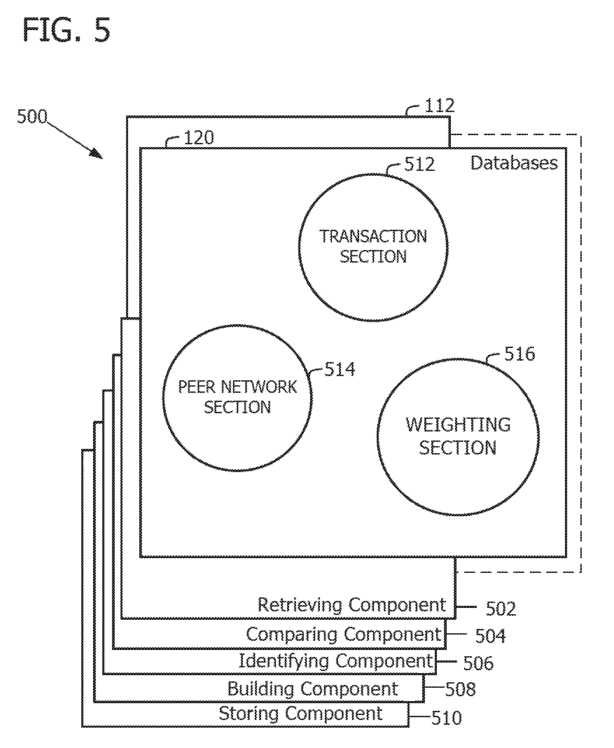

FIG. 5 is a diagram 500 of components of one or more example computing devices that may be used in the environment shown in FIG. 4. FIG. 5 further shows a configuration of databases including at least database 120 (shown in FIG. 1). Database 120 is coupled to several separate components within NB computing device 112, which perform specific tasks.

NB computing device 112 includes a retrieving component 502 configured to retrieve historical transaction data for a candidate cardholder and to retrieve historical transaction data for a plurality of model cardholders. NB computing device 112 includes a comparing component 504 configured to compare the historical transaction data for the candidate cardholder to the historical transaction data for the model cardholders. NB computing device 112 additionally includes an identifying component 506 configured to identify one or more matching historical data elements between historical data elements associated with the candidate cardholder and historical data elements associated with the model cardholders. NB computing device 112 further includes a building component 508 configured to build a peer network between the candidate cardholder and a first set of the model cardholders associated with the matching historical data elements. NB computing device 112 also includes a storing component 510 configured to store the peer network in a memory associated with NB computing device 112, such as database 120.

In an exemplary embodiment, database 120 stores different types of data, including, but not limited to, transaction data 512, peer network data 514, and weighting data 516. Database 120 is configured to retrieve, transmit, and update each type of data as required.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A network builder (NB) computing device for building a peer network used to authenticate suspect payment transactions and thereby improve data security over a payment network, said NB computing device comprising a processor in communication with a memory, said processor configured to:
retrieve candidate historical transaction data for a candidate cardholder including a first plurality of historical data elements;
retrieve model historical transaction data for a plurality of model cardholders including a second plurality of historical data elements, the model historical transaction data including previously authenticated and authorized payment transactions;
compare the candidate historical transaction data to the model historical transaction data;
identify matching historical data elements between the first plurality of historical data elements and the second plurality of historical data elements;
build a first peer network between the candidate cardholder and a first set of model cardholders of the plurality of model cardholders associated with the matching historical data elements; and
store the first peer network in the memory.

2. The NB computing device of claim 1, wherein said processor is further configured to:
receive first transaction data associated with a suspect payment transaction made by the candidate cardholder from a payment processor, the first transaction data including a plurality of suspect data elements;
retrieve the first peer network associated with the candidate cardholder, the first peer network including a plurality of peer data elements;
compare the first transaction data and the first peer network;
identify matching peer data elements between the plurality of suspect data elements and the plurality of peer data elements for each model cardholder associated with the first peer network; and
authenticate the suspect payment transaction based on the identified matching peer data elements.

3. The NB computing device of claim 2, wherein said processor is further configured to generate an aggregated confidence score associated with the first transaction data based on the identified matching peer data elements of the first set of model cardholders.

4. The NB computing device of claim 2, wherein said processor is further configured to apply a weighting factor to at least one peer data element of the matching peer data elements.

5. The NB computing device of claim 1, wherein each of the plurality of suspect data elements and the plurality of peer data elements include at least one of a transaction amount, a merchant identifier, a location identifier, a time and date stamp, and cardholder information.

6. The NB computing device of claim 1, wherein said processor is further configured to:
identify a second set of matching historical data elements between the first plurality of historical data elements and the second plurality of historical data elements;
build a second peer network between the candidate cardholder and a second set of model cardholders of the plurality of model cardholders associated with the second set of matching historical data elements; and
store the second peer network in the memory.

7. The NB computing device of claim 5, wherein said processor is further configured to
receive first transaction data associated with a suspect purchase made by the candidate cardholder from a payment processor, the first transaction data including a plurality of suspect data elements;
retrieve the first and second peer networks associated with the candidate cardholder, each of the first and second peer networks including a plurality of peer data elements;
compare the first transaction data to the first peer network and the second peer network;
identify matching peer data elements between the plurality of suspect data elements and the plurality of peer data elements of the first and second peer networks for each model cardholder associated with the peer networks; and
generate an aggregated confidence score associated with the candidate cardholder based on the identified matching peer data elements of the first peer network and the second peer network.

8. The NB computing device of claim 1, wherein said processor is further configured to determine the matching historical data elements exceed a threshold value before building the first peer network.

9. A method for building a peer network used to authenticate suspect payment transactions and thereby improve data security over a payment network, said method comprising:
retrieving, by a network building (NB) computing device, candidate historical transaction data for a candidate cardholder including a first plurality of historical data elements;
retrieving model historical transaction data for a plurality of model cardholders including a second plurality of historical data elements, the model historical transaction data including previously authenticated and authorized payment transactions;
comparing, by the NB computing device, the candidate historical transaction data to the model historical transaction data;
identifying, by the NB computing device, matching historical data elements between the first plurality of historical data elements and the second plurality of historical data elements;
building, by the NB computing device, a first peer network between the candidate cardholder and a first set of model cardholders of the plurality of model cardholders associated with the matching historical data elements; and
storing the first peer network in a memory associated with the NB computing device.

10. The method of claim 9 further comprising:
receiving, by the NB computing device, first transaction data associated with a suspect purchase made by the candidate cardholder from a payment processor, the first transaction data including a plurality of suspect data elements;
retrieving the first peer network associated with the candidate cardholder, the first peer network including a plurality of peer data elements;
comparing, by the NB computing device, the first transaction data and the first peer network;
identifying, by the NB computing device, matching peer data elements between the plurality of suspect data elements and the plurality of peer data elements for each model cardholder associated with the first peer network; and
authenticating the suspect purchase based on the identified matching peer data elements.

11. The method of claim 10 further comprising generating, by the NB computing device, an aggregated confidence score associated with the first transaction data based on the identified matching peer data elements of the first set of model cardholders.

12. The method of claim 10 further comprising applying, by the NB computing device, a weighting factor to at least one peer data element of the matching peer data elements.

13. The method of claim 9, wherein each of the first plurality of historical data elements and the second plurality of historical data elements include at least one of a transaction amount, a merchant identifier, a location identifier, a time and date stamp, and cardholder information.

14. The method of claim 9, wherein said processor is further configured to:
identifying a second set of matching historical data elements between the first plurality of historical data elements and the second plurality of historical data elements;
building, by the NB computing device, a second peer network between the candidate cardholder and a second set of model cardholders of the plurality of model cardholders associated with the second set of matching historical data elements; and
storing the second peer network within the memory.

15. The method of claim 14 further comprising:
receiving first transaction data associated with a suspect purchase made by the candidate cardholder from a payment processor, the first transaction data including a plurality of suspect data elements;
retrieving, by the NB computing device, the first and second peer networks associated with the candidate cardholder, each of the first and second peer networks including a plurality of peer data elements;
comparing the first transaction data to the first peer network and the second peer network;
identifying, by the NB computing device, matching peer data elements between the plurality of suspect data elements and the plurality of peer data elements of the first and second peer networks for each model cardholder associated with the peer networks; and
generating, by the NB computing device, an aggregated confidence score associated with the candidate cardholder based on the identified matching peer data elements of the first peer network and the second peer network.

16. The method of claim 9, wherein identifying the matching historical data elements further comprises determining the matching historical data elements exceed a threshold value before building the first peer network.

17. Computer-readable storage media for building a peer network used to authenticate suspect payment transactions and thereby improve data security over a payment network, the computer-readable storage media having computer-executable instructions embodied thereon, wherein, when executed by at least one processor, the computer-executable instructions cause the processor to:
retrieve candidate historical transaction data for a candidate cardholder including a first plurality of historical data elements;
retrieve model historical transaction data for a plurality of model cardholders including a second plurality of historical data elements, the model historical transaction data including previously authenticated and authorized payment transactions;
compare the candidate historical transaction data to the model historical transaction data;
identify matching historical data elements between the first plurality of historical data elements and the second plurality of historical data elements;
build a first peer network between the candidate cardholder and a first set of model cardholders of the plurality of model cardholders associated with the matching historical data elements; and
store the first peer network in a memory associated with the processor.

18. The computer-readable storage media of claim 17, wherein the computer-executable instructions further cause the processor to:
receive first transaction data associated with a suspect payment transaction made by the candidate cardholder from a payment processor, the first transaction data including a plurality of suspect data elements;
retrieve the first peer network associated with the candidate cardholder, the first peer network including a plurality of peer data elements;
compare the first transaction data and the first peer network;
identify matching peer data elements between the plurality of suspect data elements and the plurality of peer data elements for each model cardholder associated with the first peer network; and
authenticate the suspect payment transaction based on the identified matching peer data elements.

19. The computer-readable storage media of claim 18, wherein the computer-executable instructions further cause the processor to generate an aggregated confidence score associated with the first transaction data based on the identified matching peer data elements of the plurality of model cardholders.

20. The computer-readable storage media of claim 18, wherein the computer-executable instructions further cause the processor to apply a weighting factor to at least one peer data element of the matching peer data elements.

21. The computer-readable storage media of claim 17, wherein each of the first plurality of historical data elements and the second plurality of historical data elements include at least one of a transaction amount, a merchant identifier, a location identifier, a time and date stamp, and cardholder information.

22. The computer-readable storage media of claim 17, wherein the computer-executable instructions further cause the processor to:
identify a second set of matching historical data elements between the first plurality of historical data elements and the second plurality of historical data elements;
build a second peer network between the candidate cardholder and a second set of model cardholders of the plurality of model cardholders associated with the second set of matching historical data elements; and
store the second peer network in the memory.

23. The computer-readable storage media of claim 22, wherein the computer-executable instructions further cause the processor to:
receive first transaction data associated with a suspect purchase made by the candidate cardholder from a payment processor, the first transaction data including a plurality of suspect data elements;
retrieve the first and second peer networks associated with the candidate cardholder, each of the first and second peer networks including a plurality of peer data elements;
compare the first transaction data to the first peer network and the second peer network;
identify matching peer data elements between the plurality of suspect data elements and the plurality of peer data elements of the first and second peer networks for each model cardholder associated with the peer networks; and
generate an aggregated confidence score associated with the candidate cardholder based on the identified matching peer data elements of the first peer network and the second peer network.

24. The computer-readable storage media of claim 17, wherein the computer-executable instructions further cause the processor to determine the matching historical data elements exceed a threshold value before building the first peer network.
